(19) United States
(12) Patent Application Publication
(10) Pub. No.: US 2009/0069183 A1
(43) Pub. Date: Mar. 12, 2009

(54) AGRICULTURAL COMPOSITIONS FOR THROUGH BARK APPLICATION TO WOODY PLANTS

(76) Inventor: William Stringfellow, Louisburg, KS (US)

Correspondence Address: Arthur M. Reginelli;Renner, Kenner, Greive, Bobak, Taylor & Weber, Fourth Floor, First National Tower, Akron, OH, 44308-1456, US

(21) Appl. No.: 12/272,376

(22) Filed: Nov. 17, 2008

Related U.S. Application Data
(63) Continuation of application No. 10/566,812, filed on Jan. 25, 2007.
(60) Provisional application No. 60/493,636, filed on Aug. 8, 2003.
(60) Provisional application No. 60/493,637, filed on Aug. 8, 2003.

(51) Int. Cl. A01N 43/90; A01N 43/38; A01N 51/00; A01N 43/40

(52) U.S. Cl. 504/241; 504/284; 514/471; 514/341

(57) ABSTRACT

A method for applying a fungicide to a tree, the method comprising applying an aqueous insecticide or plant growth regulator composition to the bark periderm of woody plants without mechanically penetrating or piercing the bark of the plant, the insecticide or a plant growth regulator composition including (a) an insecticide or a plant growth regulator; (b) an organosiloxane surfactant; and (c) water.

This application Continuation Application of U.S. Non-provisional Ser. No. 10/566,812 filed Jan. 25, 2007, and claims the benefit of International Application No. PCT/US2004/025498, filed Aug. 6, 2004, which claims the benefit of U.S. Provisional Application Nos. 60/493,636, filed Aug. 8, 2003, and 60/493,637, filed Aug. 8, 2003, which are incorporated herein by reference.

### FIELD OF THE INVENTION

This invention relates to agricultural compositions, namely insecticidal and plant growth regulator compositions, and methods for using the same to treat plants through application of the composition to the periderm of the plant.

### BACKGROUND OF THE INVENTION

Many insects have had a significant impact on species of woody plants over the years. For example, Emerald Ash borer, which is an insect introduced from Europe, has eliminated many of the ash trees in North America. Similarly, Bronze Birch Borer, which is also an insect, has eliminated many of the larger Birch trees over the last 100 years. Today, Emerald Ash Borer threatens many Ash trees. And other insects such as Japanese Beetle, Leaf Minors, Flat Headed Borers, Black Vine Weevil, Midgets, Lepidopteria and Psyllidas, attack various important plants species through out the United States.

The ability to control or eliminate these insects is therefore ecologically and economically critical. The solution to the problem is two-fold. First, an effective insecticide must be identified. And second, an efficient means to systemically deliver these insecticides must be developed.

Various systemic insecticides that have been employed to treat plants infected with insects including Pyrroles, Pyriproxyfens, Chloronicotines, Nitroguadines, Abamectin, and others. These insecticides operate systemically by moving throughout the plant's vascular system to attack and interrupt the insect's metabolic life cycle processes when the insects feed or come into contact with insecticides on or in the plant.

In order to have a systemic impact on the tree, however, these insecticides must be introduced to the trees' vascular system. This can be accomplished by soaking the soil around the tree or by spraying the leaves, i.e., foliar treatment. These methods, however, are not very efficacious and result in chemical trespass to the surrounding environment. Another approach includes direct injection of the insecticide into the tree. While the later method has proven to be efficacious in delivering the insecticide to the vascular system of the tree, the method has other negative impact. To begin with, the applicator must drill a hole in the trunk of the tree or puncture the bark layer with a needle-type device, and then employ specialized equipment to inject the insecticide. Not only is this costly, time consuming, and labor intensive, but the tree can be damaged by the wounds or drilling holes or the needle puncture in the trunk, and also by the concentrated quantity of insecticide injected into a small-localized area. Also, the pressure required to force insecticide into the injection site can cause damage to the trunk as the bark can be lifted away from the sapwood.

Likewise, controlling plant growth is ecologically and economically critical. Namely, there has been a need for many years to manage woody plant growth, fruiting response, bloom initiation, fruit drop, and seed suppression.

Various plant growth regulators that have been employed to manage plant growth including Triazoles, Hydrazide, Ancymidol, Chlormequat chloride, Dikegulac sodium, methyal esters of fatty acids, gibberellic acid and combinations of, Ethephon, and Iba and combinations of IBA and NAA many others. It is believe that these plant growth regulars operate by moving through the plant's vascular system to a interrupt the plants' metabolic life cycle processes of growth, fruiting, cell division and other metabolic processes involved in plant growth within the plant.

As with the systemic insecticides, plant growth regulators must be introduced to the plants' vascular system. The same problems and shortcomings therefore exist with use of these systemic plant growth regulators that exist with systemic insecticides.

While the need to employ systemic insecticides or systemic plant growth regulators remains critical to the agricultural industry, a need exists for an alternative method for applying these compositions or for alternative compositions that do not have the disadvantages associated with the current systemic plant growth regulators and insecticides.

### SUMMARY OF THE INVENTION

In general the present invention provides an agricultural composition for topical application to woody plant periderm, the composition comprising (a) an insecticide or a plant growth regulator, (b) an organosiloxane surfactant, and (c) water.

The present invention also includes an agricultural composition for topical application to woody plant periderm, the composition comprising (A) an aqueous solution comprising (i) at least one part by weight of an insecticidal compound or a plant growth regulator, and (ii) from about 0.0001 to about 3.0 parts by weight of an organosiloxane surfactant per part of the insecticidal compound or a plant growth regulator.

The present invention further provides a method for preventing and controlling insect attack or plants having bark periderm, the method comprising applying an insecticidal composition to the bark periderm of woody plants without mechanically penetrating the bark of the plant, said insecticidal composition comprising an aqueous solution comprising i) at least one part by weight of an insecticidal compound, and (ii) from about 0.0001 to about 3.0 parts by weight of an organosiloxane surfactant per part of the insecticidal compound.

The present invention still further provides a method for preventing and controlling plant growth, the method comprising applying a plant growth regulator composition to the bark periderm of woody plants without mechanically penetrating the bark of the plant, said plant growth regulator composition comprising an aqueous solution comprising i) at least one part by weight of a plant growth regulator, and (ii) from about 0.0001 to about 1.0 parts by weight of an organosiloxane surfactant per part of plant growth regulator.

### DETAILED DESCRIPTION OF ILLUSTRATIVE EMBODIMENTS

The agricultural compositions of this invention can be applied directly to the periderm of woody plants. These compositions can be applied to the periderm of woody plants without the need for mechanically penetrating or violating the periderm of the of the woody plant. The term periderm refers to the outer layer of tissue around the stems and the like of woody plants. As those skilled in the art appreciate, this periderm is a cortical protective layer of many roots and stems that typically include phellem, phellogen, and phelloderm.

In one embodiment, the compositions include an insecticide and an organosiloxane surfactant. In a second embodiment, the compositions include a plant growth regulator and an organosiloxane surfactant. The compositions may also include other ingredients or constituents that are commonly employed in agricultural compositions such as, but not limited to, solvents, surface-active agents, or pH regulators.

Numerous insecticidal compounds can be used. Preferred insecticidal compounds are systemic insecticides. Useful systemic insecticidal compounds include nitroguanidine, acetamprid, imidaclorprid, spinosad, abamectin, pyriproxfen, pymetrozine, clofentezine, hexythiazox, diflubenzuron, chlorfenapyr, novaluron, diflubenzon, azadicrchtin, and fenpyroximate.

Numerous plant growth regulator compounds can be used. Systemic plant growth regulators are preferred. Plant growth regulators include antiauxins, auxins, cytokinins, defoliants, ethylene inhibitors, ethylene releasers, gibberellins, growth inhibitors, growth retardants, growth stimulators, and unclassified plant growth regulators.

Antiauxins include clofibric acid and 2,3,5-tri-iodobenzoic acid. Auxins include 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, and 2,4,5-T.

Cytokinins include 2iP, benzyladenine, kinetin, and zeatin. Defoliants include calcium cyanamide, dimethipin, endothal, ethephon, metoxuron, pentachlorophenol, thidiazuron, and tribufos.

Ethylene inhibitors include aviglycine, and 1-methylcyclopropene. Ethylene releasers include ACC, etacelasil, ethephon, and glyoxime. Gibberellins include gibberellins, and gibberellic acid.

Growth inhibitors include abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, 2,3,5-tri-iodobenzoic acid, and morphactins such as chlorfluren, chlorflurenol, dichlorflurenol, and flurenol.

Growth retardants include chlormequat, daminozide, flurprimidol, mefluidide, paclobutrazol, tetcyclacis, and uniconazole. Growth stimulators include brassinolide, forchlorfenuron, and hymexazol.

Unclassified plant growth regulators include benzofluor, buminafos, carvone, ciobutide, clofencet, cloxyfonac, cyclanilide, cycloheximide, epocholeone, ethychlozate, ethylene, fenridazon, heptopargil, holosulf, inabenfide, karetazan, lead arsenate, methasulfocarb, prohexadione, pydanon, sintofen, triapenthenol, and trinexapac.

Useful plant growth regulators include Ancymidol, Chlormequat, Daminozide, Paclobutrazol, Uniconazole P, Gibberellic Acid, Methyl Esters of fatty acids and Cytokinins and combinations of, Ethephon, IBA, IBA, and NAA.

Preferred plant growth regulators include Ancymidol, Chlormequat, Daminozide, Paclobutrazol, Uniconazole P, Gibberellic Acid, Methyl Esters of fatty acids and Cytokinins and combinations of, Ethephon, IBA, IBA, and NAA.

The organosiloxane surfactant generally includes one or more trisiloxanes such as those described in U.S. Pat. Nos. 3,505,377 and 6,040,272, which are incorporated herein by reference. These trisiloxanes generally include polyoxyalkylene siloxanes, which may be defined by the formula

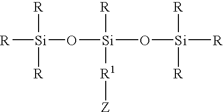

where R is a short chain alkyl group, R¹ is an alkylene group, and Z is a polyoxyalkylene group. The alkyl group may include from 1 to 6 carbon atoms and is preferably methyl. The alkylene group preferably includes from 1 to 10 carbon atoms and is preferably propylene or butylene, and most preferably propylene. The polyoxyethylene preferably includes from 1 to about 30 repeating units based on ethylene or propylene oxide, with ethyleneoxide being preferred. In one embodiment, the polyoxyalkylene group can be defined by the formula —CₙH₂ₙ O(CH₂ CH₂ O)ₐ R², in which n is 3 or 4, a is 1 to about 30, and R² is hydrogen, methyl, ethyl, or an acetyl group. Preferably, blends of two or more alkyl substituted polyalkylene siloxanes are employed in practicing the present invention.

The preferred alkyl substituted polyoxyalkylene siloxanes include polyoxyethylene heptamethyl trisiloxanes. More specifically, the preferred polyoxyethylene heptamethyl trisiloxanes, include those where n is 3 such that a n-propylene or —(CH₂)₃-bridge is present between the middle silicon atom of the trisiloxane group and the polyoxyethylene chain and a is about 5 to about 15. Especially preferred trisiloxanes of this type are commercially available under the tradenames Silwet™ L-77, Silwet™ 408 and Silwet™ 800 (OSI Specialties), Sylgard™ 309 (Dow Corning), Qwikwet™ 100, Qwikwet™ 357, Qwikwet™ 391 (Exacto Inc.), and Kinetic™ (Helena Chemical).

Additionally, the compositions of this invention may also optionally include a solvent. The compounds that are useful as solvents provide a number of advantageous properties and are therefore generically described in different ways by those skilled in the art. For example, these solvents may also be referred to as coupling agents, emulsifiers, humectants, and pour point depressants.

Useful solvents include alcohols, glycols, glycol esters, and the like. Examples of alcohols include methanol, ethanol, n-propanol, isopropanol, n-butanol, isobutanol, amyl alcohol, methyl amyl alcohol, cyclohexanol, 2-ethylhexanol, furfuryl alcohol, and d-limonene. Examples of glycols and glycol esters include monoethylene glycol, diethylene glycol, propylene glycol or the methyl, ethyl, n-propyl, n-butyl or t-butyl ethers thereof, dipropylene glycol or the methyl, ethyl, n-propyl, n-butyl or t-butyl ethers thereof, tripropylene glycol, or the methyl, ethyl, n-propyl, n-butyl or t-butyl ethers thereof, 1,3-butanediol, 1,4-butanediol, 2-methyl-1,3-propanediol, 2,2-dimethyl-1,3-propanediol, 2-methyl-1,3-pentanediol, 2-methyl-2,4-pentanediol, 2-methyl-1,3-propanediol and 1,4-butanediol. Blends of various solvents may also be used.

Additionally, the compositions of this invention may also optionally include a surface-active agent. Surface-active agents include those compounds defined by ASTM E1519-99, which are materials that when added to a liquid modify the properties of the medium at the surface or interface. These agents are generally known and described in U.S. patent Application No. 20020107149, which is incorporated herein by reference.

Useful surface active agents include Methylated C₆-C₁₉ fatty acids, Methylated Tall oil fatty acids, Methylated Oleic acid, Methylated Linoleic acid, Methylated Linolenic acid, Methylated Stearic acid, Methylated Palmitic acid, Ethylated C₆-C₁₉ fatty acids, Ethylated Tall oil fatty acids, Ethylated Oleic acid, Ethylated Linoleic acid, Ethylated Linolenic acid, Ethylated Stearic acid, Ethylated Palmitic acid, Butylated C₆-C₁₉ fatty acids, Butylated Tall oil fatty acids, Butylated Oleic acid, Butylated Linoleic acid Butylated Linolenic acid, Butylated Stearic acid, Butylated Palmitic acid, Methylated soybean oil, Ethylated soybean oil, Butylated soybean oil, Methylated canola oil, Ethylated canola oil, Butylated canola oil, Methylated coconut oil, Ethylated coconut oil, Butylated coconut oil, Methylated sunflower oil, Ethylated sunflower oil, Butylated sunflower oil, Paraffinic mineral oils, Naphthenic mineral oils, Aromatic mineral oils, Soybean oil, Canola oil, Cottonseed oil, C₆-C₁₉ fatty acids, Tall oil fatty acids, Oleic acid, Linoleic acid, Linolenic acid, Stearic acid, Palmitic acid, Epoxified soybean oil, Alcohol alkoxylate, Alcohol alkoxylate sulfate, Alkylphenol alkoxylate, Alkanolamide, Alkylaryl sulfonate, Amine oxide, Amine, Betaine derivative, Block polymers of ethylene and propylene glycol, Carboxylated alcohol or alkylphenol alkoxylate, Diol, Diphenyl sulfonate derivative, Ether, Ethoxylated amine, Ethoxylated fatty acid, Ethoxylated fatty ester and oils, Ethylene carbonate, Fatty ester, Glycerol ester, Glycol, Phosphate ester surfactant, Propylene Carbonate, Sarcosine derivative, Siloxane-based surfactant, Sorbitan derivative, Sucrose derivative, glucose derivative, Sulfate of alkoxylated alkylphenol, sulfonate of alkoxylated alkylphenol, Sulfate of alcohol, tristyrylphenol alkoxylate, alcohol alkoxylates based on branched and linear alcohols containing ethylene oxide or propylene oxide alcohol alkoxylate sulfates, nonylphenol alkoxylate containing ethylene oxide, nonylphenol alkoxylate containing propylene oxide, octylphenols alkoxylate containing ethylene oxide octylphenols alkoxylate containing propylene oxide, fatty amine alkoxylates, butanediols, butyl cellulose ether, butyl carbitol, propylene glycol, ethylene glycol, dipropylene glycol, diethylene glycol, phosphate esters of alcohol alkoxylates, phosphate esters of alkylphenol alkoxylates, sorbitan esters, alkoxylated sorbitan esters and alkylpolyglucosides. Blends of this foregoing surface-active agents may also be employed.

In certain embodiments, the pH of the aqueous compositions of this invention is maintained at a pH of about 2 to about 9, more preferably from about 5 to about 7, and even more preferably from about 5.5 to about 6.5. The pH is maintained to prevent the phosphite compounds form being oxidized into phosphate compounds.

In one embodiment, the compositions of this invention include at least one part by weight of the insecticide and up to about 3.0 parts by weight of the organosiloxane surfactant. Preferably, the compositions include from about 0.0001 to about 1.0 parts by weight of the organosiloxane surfactant, preferably from about 0.001 to about 0.05 parts by weight, more preferably from about 0.003 to about 0.03 parts by weight, even more preferably from about 0.005 to about 0.1 parts by weight, and still more preferably from about 0.01 to about 0.05 parts by weight of the organosiloxane surfactant per part of the insecticide.

In another embodiment, the compositions of this invention include at least one part by weight of the plant growth regulator up to about 3.0 parts by weight of the organosiloxane surfactant. Preferably, the compositions include from about 0.0001 to about 1.0 parts by weight, preferably from about 0.001 to about 0.05 parts by weight, more preferably from about 0.003 to about 0.03 parts by weight, even more preferably from about 0.005 to about 0.1 parts by weight, and still more preferably from about 0.01 to about 0.05 parts by weight of the organosiloxane surfactant per part of the plant growth regulator.

When employed, the compositions of this invention include from about 0.0001 to about 1.0 parts by weight, preferably from about 0.001 to about 0.05 parts by weight, more preferably from about 0.005 to about 0.1 parts by weight, and even more preferably from about 0.01 to about 0.05 parts by weight of the solvent per part of the insecticide or plant growth regulator.

When employed, the compositions of this invention include from about 0.0001 to about 2.0 parts by weight, preferably from about 0.001 to about 0.05 parts by weight, more preferably from about 0.005 to about 0.1 parts by weight, and even more preferably from about 0.01 to about 0.05 parts by weight of the surface active agent per part of the insecticide or plant growth regulator.

The agricultural compositions of this invention may be applied to the bark or periderm of woody plants by employing a variety of appropriate methods that are well known to those skilled in the art. Typically, the composition is applied to individual trees, woody plants or can applied on a field basis, by employing backpack sprayers, hose end applicators, spot treatment hand spray gun or mechanized spray applicator whether ground or aerially applied. or similar equipment. Advantageously, the composition of this invention can be applied directly to the bark periderm of the plant without mechanically piercing, penetrating, or violating the bark periderm or surface of the plant.

Because the compositions of this invention are aqueous compositions, they can be prepared in a variety of concentrations. Conventionally, concentrated compositions are prepared for purposes of shipping and storage, and then the concentrate is diluted prior to application to the plants. For example, concentrate solutions may be prepared that include from about 1% to about 100% by weight, more preferably from about 10% to about 50% by weight, and more preferably from about 20% to about 40% by weight insecticide or plant growth regulator.

Although not required, the concentrate solution can be diluted at the time of application to any concentration that is believed to provide a desired result. For example, useful compositions may include from about 0.5% to about 100% by weight r, more preferably from about 5% to about 50% by weight, and even more preferably from about 10% to about 30% by weight insecticide or plant growth regulator.

The application rate or amount of treatment solution applied to the bark of a tree can vary widely; this is especially true in view of the fact that the concentration of this solution can vary. Moreover, those skilled in the art will be able to readily determine and apply an amount of solution that will be useful for treating any given tree. In general, it is preferred to spray or apply the solution to the bark of a tree until runoff. As those skilled in the art will appreciate, runoff will occur at different loading depending on the texture of the bark. In preferred embodiments, the amount of treatment solution applied to a tree can be calculated based upon the amount that is preferably applied to a standard tree. In other words, for a tree have a DBH (diameter breast height) of about six inches, and where treatment to this tree will include the entire bark surface from the foot or base of the tree up to about six feet, it is preferred to apply from about 25 to about 125 g, more preferably from about 35 to about 105 g, even more preferably from about 45 to about 95 g, and even more preferably form about 50 to about 75 g of the active component (e.g., insecticide or plant growth regulator).

Although the composition of this invention have been described as aqueous solutions, the scope of the invention should not be limited thereto. Accordingly, the term aqueous, as used in the specification is not intended to exclude the presence of a small amount of non-aqueous solvent or dispersions or partial dispersions of the active ingredients disclosed herein.

Various modifications and alterations that do not depart from the scope and spirit of this invention will become apparent to those skilled in the art. This invention is not to be duly limited to the illustrative embodiments set forth herein.

What is claimed is:

1. A method for applying a fungicide to a tree, the method comprising:
applying an aqueous insecticide or plant growth regulator composition to the bark periderm of woody plants without mechanically penetrating or piercing the bark of the plant, the insecticide or a plant growth regulator composition including (a) an insecticide or a plant growth regulator; (b) an organosiloxane surfactant; and (c) water.

2. The method of claim 1, where said step of applying includes spraying an insecticide or a plant growth regulator composition on the bark periderm.

3. The method of claim 1, where said step of applying includes an application rate corresponding to applying about 25 to about 125 grams of an insecticide or a plant growth regulator to six feet of a tree, measured from the base, where the tree has a diameter breast height of about six inches.

4. The method of claim 1, where said step of applying includes an application rate corresponding to applying about 35 to about 105 grams of an insecticide or a plant growth regulator to six feet of a tree, measured from the base, where the tree has a diameter breast height of about six inches.

5. The method of claim 1, where said step of applying includes an application rate corresponding to applying about 45 to about 95 grams of an insecticide or a plant growth regulator to six feet of a tree, measured from the base, where the tree has a diameter breast height of about six inches.

6. The method of claim 1, where said step of applying includes an application rate corresponding to applying about 50 to about 75 grams of an insecticide or a plant growth regulator to six feet of a tree, measured from the base, where the tree has a diameter breast height of about six inches.

7. The method of claim 1, where the insecticide or a plant growth regulator composition includes a solvent selected from the group consisting of alcohols, glycols, and glycol esters.

8. The method of claim 7, where the insecticide or a plant growth regulator composition includes a surface active agent is selected from the group consisting alcohol alkoxylates based on branched and linear alcohols containing ethylene oxide or propylene oxide, alcohol alkoxylate sulfates, nonylphenol alkoxylate containing ethylene oxide, nonylphenol alkoxylate containing propylene oxide, octylphenols alkoxylate containing ethylene oxide, octylphenols alkoxylate containing propylene oxide, fatty amine alkoxylates, butanediols, butyl cellulose ether, butyl carbitol, propylene glycol, ethylene glycol, mipropylene glycol, diethylene glycol, phosphate esters of alcohol alkoxylates, phosphate esters of alkylphenol alkoxylates, sorbitan esters, alkoxylated sorbitan esters and alkylpolyglucosides.

9. The method of claim 1, where the insecticide or a plant growth regulator composition includes from about 0.0001 to about 3.0 parts by weight of the organosiloxane surfactant per part of an insecticide or a plant growth regulator.

10. The method of claim 1, where the insecticide or a plant growth regulator composition includes from about 0.003 to about 0.05 parts by weight of the organosiloxane surfactant per part of systemic fungicide.

11. The method of claim 8, where the insecticide or a plant growth regulator composition includes from about 0.0001 to about 1.0 parts by weight solvent per part of an insecticide or a plant growth regulator, and where the insecticide or a plant growth regulator composition includes from about 0.0001 to about 2.0 parts by weight surface active agent per part of an insecticide or a plant growth regulator.

12. The method of claim 1, where the organosiloxane surfactant includes a trisiloxane defined by the formula 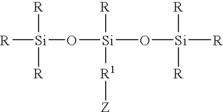
where R is a short chain alkyl group, R¹ is an alkylene group, and Z is a polyoxyalkylene group.

13. The method of claim 12, where the organosiloxane includes a polyoxyethylene heptamethyl trisiloxane.

14. The method of claim 1, where said step of applying an insecticide or a plant growth regulator composition to the bark periderm of woody plants includes applying the insecticide or a plant growth regulator composition to the bark of the woody plant in a location from the root flare up to the first branch of the plant.

15. The method of claim 14, where said step of applying an insecticide or a plant growth regulator composition to the bark periderm of woody plants includes applying the insecticide or a plant growth regulator composition to the bark of the woody plant in a location from the root flare up to the second branch of the plant.

16. The method of claim 14, where said step of applying includes an application rate corresponding to applying about 25 to about 125 grams of insecticide or a plant growth regulator to six feet of a tree, measured from the base, where the tree has a diameter breast height of about six inches.

17. The method of claim 14, where said step of applying includes an application rate in an amount that the insecticide or a plant growth regulator composition will runoff the bark.

18. The method of claim 14, where the bark periderm of the woody plant to which the insecticide or a plant growth regulator composition is applied consists that portion between the root flare and the first branch.

19. The method of claim 1, where the insecticide is a systemic insecticide selected from the group consisting of nitroguanidine, acetamprid, imidaclorprid, spinosad, abamectin, pyriproxfen, pymetrozine, clofentezine, hexythiazox, diflubenzuron, chlorfenapyr, novaluron, diflubenzon, azadicrchtin, and fenpyroximate, or where the plant growth regulator is a systemic plant growth regulator selected from the group consisting of antiauxins, auxins, cytokinins, defoliants, ethylene inhibitors, ethylene releasers, and gibberellins.

20. The method of claim 12, where the insecticide is a systemic insecticide selected from the group consisting of acetamprid and imidaclorprid.
